(19) United States
(12) Patent Application Publication
(10) Pub. No.: US 2024/0408924 A1
(43) Pub. Date: Dec. 12, 2024

(54) VEHICLE SUPPORT STRUCTURE AND METHOD OF MANUFACTURING VEHICLE SUPPORT STRUCTURE

(71) Applicants: Hitachi Astemo, Ltd., Hitachinaka-shi (JP); HONDA MOTOR CO., LTD., Tokyo (JP)

(72) Inventors: Yutaro Yamazaki, Hitachinaka-shi (JP); Yasuhiro Maruyama, Hitachinaka-shi (JP); Kazuhiro Terada, Hitachinaka-shi (JP); Takafumi Kobayashi, Tokyo (JP); Tao Tan, Tokyo (JP)

(73) Assignees: Hitachi Astemo, Ltd., Hitachinaka-shi (JP); HONDA MOTOR CO., LTD., Tokyo (JP)

(21) Appl. No.: 18/733,188

(22) Filed: Jun. 4, 2024

(30) Foreign Application Priority Data
Jun. 12, 2023 (JP) 2023-096043

(51) Int. Cl. B60G 7/00; B22D 25/02

(52) U.S. Cl. CPC B60G 7/001; B22D 25/02; B60G 2206/8101; B60G 2206/8111

(57) ABSTRACT

Provided is a suspension arm manufactured by casting. The suspension arm includes a processing reference hole formed in the casting. The processing reference hole is formed to be elongated in a direction of bending of the suspension arm that occurs in a shaping step. A recess is formed which has one end thereof communicating with the processing reference hole and another end thereof being open to an outer side.

### TECHNICAL FIELD

The present disclosure relates to a vehicle support structure and a method of manufacturing the vehicle support structure, and relates specifically to a vehicle support structure manufactured by casting and including a processing reference hole to be used for positioning in machining of the cast body after the casting, and a method of manufacturing the vehicle support structure.

### BACKGROUND

Heretofore, vehicle support structures manufactured by casting undergo machining (processing step) in a state where the cast body after a shaping step is positioned with a jig inserted in a processing reference hole provided in the cast body, and this processing reference hole is formed with a core in the shaping step (see Published Japanese Translation of PCT International Application No. 2007-506924 (Patent Document 1), for example).

### SUMMARY

Here, the vehicle support structure in Patent Document 1 mentioned above may experience displacement of the processing reference hole due to deformation of the cast body, such as bending, that occurs in the shaping step. This may result in a failure to insert the positioning jig into the displaced processing reference hole during the machining. Even if the jig can be inserted, it may not be able to reliably support the processing reference hole. Moreover, water may accumulate in the processing reference hole in the vehicle support structure mounted to a vehicle and cause corrosion. This leads to a possibility of lowering the strength.

In view of the above, it is preferable to provide a vehicle support structure including a processing reference hole into which a positioning jig can be inserted during machining to reliably support the cast body, and which can prevent water from accumulating therein in a state where the vehicle support structure is mounted to a vehicle, and to provide a method of manufacturing the vehicle support structure.

One aspect of the vehicle support structure of the present disclosure is a vehicle support structure manufactured by casting, the vehicle support structure including a processing reference hole formed in the casting, in which the processing reference hole is formed to be elongated in a direction of bending of the vehicle support structure that occurs in a shaping step, and a recess is formed which has one end thereof communicating with the processing reference hole and another end thereof being open to an outer side.

Also, it is preferable that a bottom of the processing reference hole and a bottom of the recess be inclined downward in a direction of gravity toward the other end of the recess.

Moreover, it is preferable that the vehicle support structure be a suspension arm, and the processing reference hole be disposed in an upper surface of the suspension arm in a state of being mounted to a vehicle around a portion of the suspension arm to which to connect another component.

Also, one aspect of the method of manufacturing a vehicle support structure of the present disclosure is a method of manufacturing a vehicle support structure to be manufactured by casting, the method comprising shaping a processing reference hole and a recess in the vehicle support structure in the casting, the processing reference hole being elongated in a direction of bending of the vehicle support structure that occurs in a shaping step, the recess having one end thereof communicating with the processing reference hole and another end thereof being open to an outer side.

Moreover, the shaping step includes a heat treatment step, and the direction of the bending of the vehicle support structure is the same as a direction of bending that occurs in the heat treatment step.

Also, the shaping step includes a releasing step, and the direction of the bending of the vehicle support structure is the same as a direction of bending that occurs in the releasing step.

In the vehicle support structure of the present disclosure, for example, the processing reference hole is formed to be elongated in the direction of the bending of the vehicle support structure. In this way, a positioning jig can be inserted into the processing reference hole even if bending occurs in casting, causing a displacement of the processing reference hole in the direction of the bending. Moreover, the processing reference hole can be reliably supported with the jig by bringing the jig into contact with the side walls of the processing reference hole in the width direction. Furthermore, even if water enters the processing reference hole in a state where the vehicle support structure is mounted to a vehicle, the entered water will be discharged through the recess. This can prevent accumulation of water in the processing reference hole.

Also, the bottom of the processing reference hole and the bottom of the recess are inclined downward in the direction of gravity toward the other end of the recess. In this way, water having entered the processing reference hole will be reliably discharged, so that water will not accumulate in the processing reference hole. This also prevents corrosion of the processing reference hole by water and thus eliminates the possibility of such corrosion affecting a portion to which to connect another component when the processing reference hole is provided near this portion to connect another component.

Moreover, with the method of manufacturing a vehicle support structure of the present disclosure, for example, it is possible to easily shape the processing reference hole and the recess.

Also, by forming the processing reference hole elongated in the direction of the bending that occurs in the heat treatment step and the direction of the bending that occurs in the releasing step, the positioning jig can be inserted into the processing reference hole even if such bending occurs, thus causing a displacement of the processing reference hole and the recess in the direction of the bending. Moreover, the processing reference hole can be reliably supported with the jig by bringing the jig into contact with side walls of the processing reference hole in the width direction.

### BRIEF DESCRIPTION OF THE DRAWINGS

FIG. 1 is a plan view of a suspension arm representing one embodiment of the present disclosure;

FIG. 2 is a cross-sectional view along line II-II of FIG. 1;

FIG. 3 is an explanatory diagram of the suspension arm representing the one embodiment of the present disclosure;

FIG. 4 is a plan view of a chief part of a cast body being the above suspension arm in which a processing reference hole and a recess are shaped;

FIG. 5 is a cross-sectional view along line V-V of FIG. 4;

FIG. 6 is a plan view of a chief part of a cast body being a suspension arm in which a processing reference hole is likewise shaped; and

FIG. 7 is a cross-sectional view along line VII-VII of FIG. 6.

### DETAILED DESCRIPTION

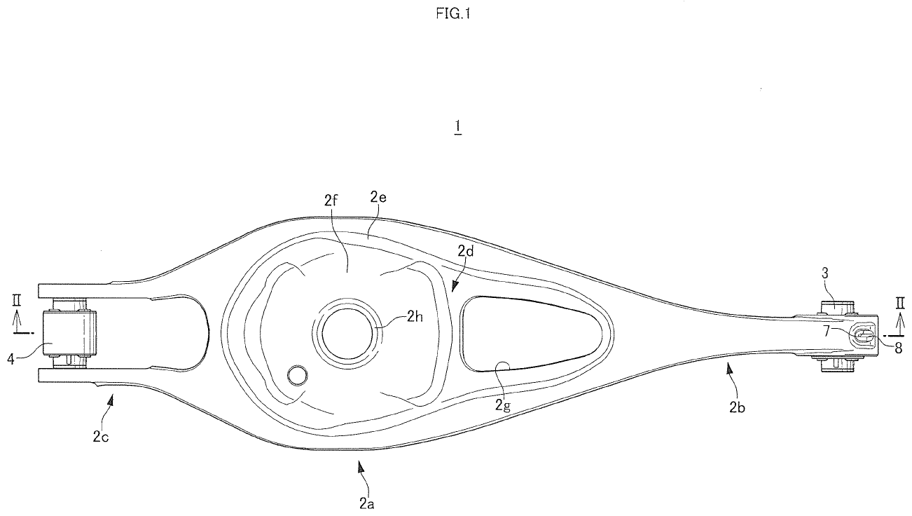

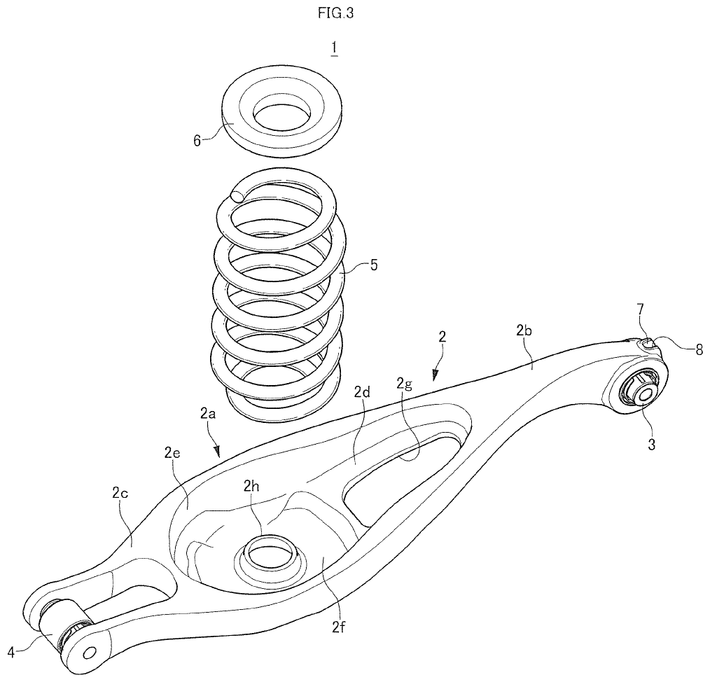

FIGS. 1 to 7 are views showing one embodiment applied to a suspension arm representing one example of a vehicle support structure. A suspension arm 1 in this embodiment is mounted as a lower arm for a vehicle's rear wheel.

The suspension arm 1 includes an arm body 2a, a vehicle body-side arm part 2b extending from the arm body 2a toward the vehicle body, and a wheel-side arm part 2c extending from the arm body 2a toward the wheel. A vehicle body-side bearing 3 is provided at the tip of the vehicle body-side arm part 2b. A wheel-side bearing 4 is provided at the tip of the wheel-side arm part 2c. The arm body 2a is formed in a concave shape including a bottom wall 2d and a side wall 2e extending upward from the bottom wall 2d. The bottom wall 2d includes a circular portion 2f formed on the wheel-side arm part 2c side and an opening portion 2g formed on the vehicle body-side arm part 2b side. A shock absorber coupling portion 2h is provided at the center of the circular portion 2f. A shock absorber (not shown) including a suspension spring 5, a rubber ring 6 for shock absorption, and so on is coupled to this shock absorber coupling portion 2h.

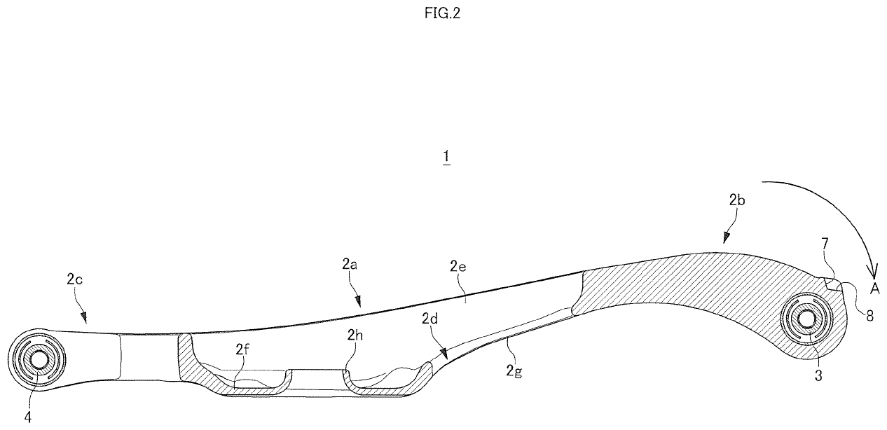

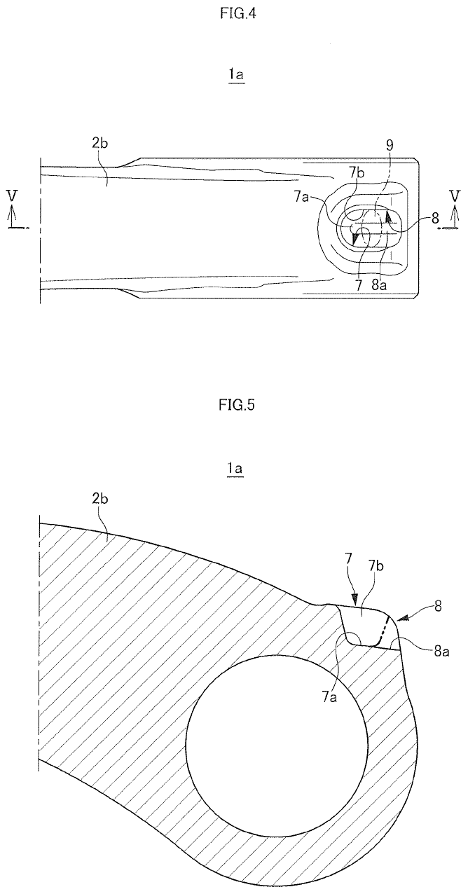

A processing reference hole 7 and a recess 8 are formed integrally with each other in the upper surface of the tip of the vehicle body-side arm part 2b (the phantom line in FIG. 5 indicates the boundary between the processing reference hole 7 and the recess 8). The processing reference hole 7 is formed longer in the bending direction of the vehicle body-side arm part 2b (the direction of the arrow A shown in FIG. 2) than in its width direction, and includes a bottom 7a and side walls 7b. The recess 8 has one end communicating with the processing reference hole 7 and the other end open at the outer side of the tip of the vehicle body-side arm part 2b. The recess 8 has a bottom 8a formed to be flush with the bottom 7a of the processing reference hole 7. The bottoms 7a and 8a are formed as to be inclined downward in the direction of gravity toward the tip side of the vehicle body-side arm part 2b (to the other end of the recess).

The above suspension arm 1 can be manufactured by a publicly known method that involves performing a shaping step in which a molten metal filling step, a releasing step, a gate cutting step, a heat treatment step, and so on are sequentially performed, and thereafter a processing step such as cutting. In the molten metal filling step, a molten metal, such as molten aluminum, is introduced and filled into a cavity inside a mold including a cover half, an ejector half, and cores that shape the processing reference hole 7 and the recess 8 (the mold and its halves are not shown). In the releasing step, the cover half and the ejector half are opened and a cast body 1a is taken out of the mold. In the gate cutting step, the gate is cut off from the cast body 1a. In the heat treatment step, the cast body 1a is heated at high temperatures for a certain time and then quickly cooled with water, and the water-cooled cast body is heated again for a certain time.

In the heat treatment step, the vehicle body-side arm part 2b, which is a long part, may experience bending (in the direction of the arrow A illustrated in FIG. 2). Also, in the releasing step, the ejector half is opened with the cast body 1a pressed with releasing pins, and then the cast body 1a remaining in the cover half is pushed with the releasing pins to take it out of the cover half. Here, the cast body 1a may experience bending (in the direction of the arrow A illustrated in FIG. 2) similar to the bending that occurs in the heat treatment step depending on the balance between the intensities of the pushes on the releasing pins and if the cast body 1a gets stuck in the cover half or the ejector half, for example.

In this embodiment, the processing reference hole 7 is formed to be elongated in the bending direction of the vehicle body-side arm part 2b (the direction of the arrow A illustrated in FIG. 2). Thus, even if bending as described above occurs, thereby displacing the processing reference hole 7 and the recess 8 in the bending direction, it will still be possible to insert a positioning jig 9 into the processing reference hole 7 (FIG. 4) when performing machining (processing step) with the jig 9 inserted in the processing reference hole 7 to position the cast body 1a. It will also be possible to reliably support the processing reference hole 7 with the jig 9 by bringing the jig 9 into contact with the side walls 7b and 7b of the processing reference hole 7 in the width direction.

Also, the recess 8 is provided, which has one end thereof communicating with the processing reference hole 7 and the other end thereof being open at the outer side of the tip of the vehicle body-side arm part 2b. In this way, even if water enters the processing reference hole 7 in the suspension arm 1 mounted to a vehicle, it will be possible to discharge the entered water through the recess 8. Moreover, the bottom 7a of the processing reference hole 7 and the bottom 8a of the recess 8 are formed to be flush with each other and are formed as to be inclined downward in the direction of gravity toward the tip side of the vehicle body-side arm part 2b. In this way, it is possible to reliably discharge the entered water. Furthermore, since water does not accumulate in the processing reference hole 7, it is possible to prevent corrosion by water. Accordingly, the vehicle body-side bearing 3 (a portion to which to connect another component in the present disclosure) will not be affected by corrosion.

Also, the processing reference hole 7 and the recess 8 are shaped with a core in casting. In this way, the processing reference hole 7 and the recess 8 are easily formed.

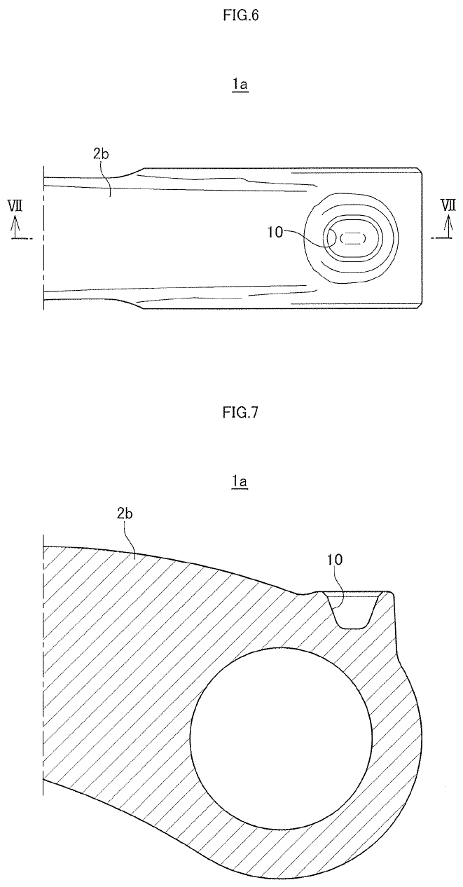

Incidentally, in the above embodiment, the processing reference hole 7 and the recess 8 are shaped with a core in casting. Alternatively, as illustrated in FIGS. 6 and 7, it is also possible to shape a processing reference hole 10 with a core in casting and then form a recess by machining (cutting). The recess is cut such as its one end communicates with the processing reference hole 10 and its other end is open to the outer side. The processing reference hole 10 has the same shape as the processing reference hole 7 with the phantom line in FIG. 5, and is formed such that the hole's diameter is longer in the bending direction of the vehicle body-side arm part 2b than in its width direction.

Also, the vehicle support structure of the present invention is not limited to suspension arms as in the above embodiment, and is applicable to various parts such as a knuckle, which joins and supports parts such as a hub bearing and an arm and various arm members that support this knuckle's movement in the vertical direction and restrict the vehicle body's movement in the left-right direction. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A vehicle support structure manufactured by casting, the vehicle support structure comprising a processing reference hole formed in the casting, wherein
the processing reference hole is formed to be elongated in a direction of bending of the vehicle support structure that occurs in a shaping step, and
a recess is formed which has one end thereof communicating with the processing reference hole and another end thereof being open to an outer side.

2. The vehicle support structure according to claim 1, wherein a bottom of the processing reference hole and a bottom of the recess are inclined downward in a direction of gravity toward the other end of the recess.

3. The vehicle support structure according to claim 1, wherein
the vehicle support structure is a suspension arm, and
the processing reference hole is disposed in an upper surface of the suspension arm in a state of being mounted to a vehicle around a portion of the suspension arm to which to connect another component.

4. A method of manufacturing a vehicle support structure to be manufactured by casting, the method comprising shaping a processing reference hole and a recess in the vehicle support structure in the casting, the processing reference hole being elongated in a direction of bending of the vehicle support structure that occurs in a shaping step, the recess having one end thereof communicating with the processing reference hole and another end thereof being open to an outer side.

5. The method of manufacturing a vehicle support structure according to claim 4, wherein
the shaping step includes a heat treatment step, and
the direction of the bending of the vehicle support structure is the same as a direction of bending that occurs in the heat treatment step.

6. The method of manufacturing a vehicle support structure according to claim 4, wherein
the shaping step includes a releasing step, and
the direction of the bending of the vehicle support structure is the same as a direction of bending that occurs in the releasing step.
